(19) United States
(12) Patent Application Publication
(10) Pub. No.: US 2010/0309372 A1
(43) Pub. Date: Dec. 9, 2010

(54) Method And System For Motion Compensated Video De-Interlacing

(76) Inventor: Sheng Zhong, San Jose, CA (US)

Correspondence Address: MCANDREWS HELD & MALLOY, LTD, 500 WEST MADISON STREET, SUITE 3400, CHICAGO, IL, 60661, US

(21) Appl. No.: 12/480,200

(22) Filed: Jun. 8, 2009

(51) Int. Cl. H04N 7/01

(52) U.S. Cl. 348/452; 348/E07.003

(57) ABSTRACT

In a video processing system, a motion compensated de-interlacer (MCDI) may read four consecutive fields of interlaced pixel data that may comprise video and/or film content. The MCDI may convert a current field of interlaced pixel data to a de-interlaced frame of pixel data. Motion may be estimated between two of the fields with up to ¼ pel precision. A motion vector may be determined based on searching a field of the same polarity. The motion vector may be scaled with up to ¼ or ⅛ pel precision for a field of an opposite polarity. A level of validity may be determined for the motion vector and/or the scaled motion vector. A motion compensated (MC) pixel value may be interpolated for a current field based on a second field comprising an opposite polarity. The MC interpolated pixel value may be blended with a pixel value determined based on another method of de-interlacing.

### CROSS-REFERENCE TO RELATED APPLICATIONS/INCORPORATION BY REFERENCE

Not Applicable

### FIELD OF THE INVENTION

Certain embodiments of the invention relate to communications. More specifically, certain embodiments of the invention relate to a method and system for motion compensated video de-interlacing.

### BACKGROUND OF THE INVENTION

In video systems, an image is presented in a display device, for example in a television, a monitor, a desktop device and/or handheld device. Most video broadcasts, nowadays, utilize video processing applications that enable broadcasting video images in the form of bit streams that comprise information regarding characteristics of the image to be displayed. These video applications may utilize various de-interlacing functions to present content comprising still and/or moving images on a display. For example, de-interlacing functions may be utilized to convert moving and/or still images to a format that is suitable for certain types of display devices that are unable to handle interlaced content.

Interlaced video comprises fields, each of which may be captured at a distinct time interval. A frame may comprise a pair of fields, for example, a top field and a bottom field. The pictures forming the video may comprise a plurality of ordered lines. During one of the time intervals, video content for the even-numbered lines may be captured. During a subsequent time interval, video content for the odd-numbered lines may be captured. The even-numbered lines may be collectively referred to as the top field, while the odd-numbered lines may be collectively referred to as the bottom field. Alternatively, the odd-numbered lines may be collectively referred to as the top field, while the even-numbered lines may be collectively referred to as the bottom field.

In the case of progressive video frames, all the lines of the frame may be captured or played in sequence during one time interval. Interlaced video may comprise fields that were converted from progressive frames. For example, a progressive frame may be converted into two interlaced fields by organizing the even numbered lines into one field and the odd numbered lines into another field.

Further limitations and disadvantages of conventional and traditional approaches will become apparent to one skilled in the art, through comparison of such systems with some aspects of the present invention as set forth in the remainder of the present application with reference to the drawings.

### BRIEF SUMMARY OF THE INVENTION

A system and/or method is provided for motion compensated video de-interlacing, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary video processing system for motion compensated video de-interlacing, in accordance with an embodiment of the invention.

FIG. 2A is a block diagram illustrating an exemplary sequence of interlaced video fields, in accordance with an embodiment of the invention.

FIG. 2B is a block diagram illustrating exemplary indexing for a sequence of interlaced video fields, in accordance with an embodiment of the invention.

FIG. 3 is a block diagram illustrating an exemplary four field motion compensated de-interlacer, in accordance with an embodiment of the invention.

FIG. 4 is a diagram illustrating two exemplary field orders for four consecutive fields of input to a motion compensated de-interlacer, in accordance with an embodiment of the invention.

FIG. 5A is a diagram illustrating motion vectors for interlace fields comprising interlaced video content, in accordance with an embodiment of the invention.

FIG. 5B is a diagram illustrating motion vectors for interlace fields comprising film content with a field order suitable for backwards inverse telecine weave, in accordance with an embodiment of the invention.

FIG. 5C is a diagram illustrating motion vectors for interlace fields comprising film content with a field order suitable for forward inverse telecine weave, in accordance with an embodiment of the invention.

FIG. 5D is a diagram illustrating motion vectors for interlace fields comprising film content with a field order where the In(2) field repeats the In(0) field, in accordance with an embodiment of the invention.

FIG. 5E is a diagram illustrating motion vectors for interlace fields comprising film content with a field order where the In(1) field repeats the In(−1) field, in accordance embodiment of the invention.

FIG. 6 is a block diagram illustrating an exemplary motion estimation process between a current field and a reference field, in accordance with an embodiment of the invention.

FIG. 7 is a block diagram illustrating an exemplary four field motion compensation de-interlacer, in accordance with an embodiment of the invention.

FIG. 8 is a block diagram illustrating an exemplary four field motion compensation de-interlacer with inverse telecine, in accordance with an embodiment of the invention.

FIG. 9 illustrates exemplary steps for de-interlacing video fields with a four field motion compensation de-interlacer with inverse telecine, in accordance with an embodiment of the invention.

### DETAILED DESCRIPTION OF THE INVENTION

Certain embodiments of the invention may be found in a method and system for motion compensated video de-interlacing. In various embodiments of the invention, a video processing system comprises a motion compensation de-interlacer (MCDI). The MCDI may be operable to read four consecutive fields of interlaced pixel data. The MCDI may be operable to utilize one or more of the four consecutive fields to convert a current field of interlaced pixel data to a de-interlaced frame of pixel data. In this regard, motion may be estimated between two of the four consecutive fields. The motion may be estimated with up to ¼ pixel (pel) precision. A motion vector may be determined based on searching a field from the four consecutive fields that may comprise a same polarity. The motion vector may be scaled with up to ¼ pel precision or finer precision such as ⅛ pel precision for a field of the four consecutive fields comprising an opposite polarity. A level of validity may be determined for the motion vector and/or the scaled motion vector. A motion compensated pixel value may be interpolated for a current field of the four consecutive fields based on a second field comprising an opposite polarity. The interpolated motion compensated pixel value may be blended with one or more pixel values that may be determined based on other methods of de-interlacing. The four consecutive fields of interlaced pixel data may comprise video content and/or film content.

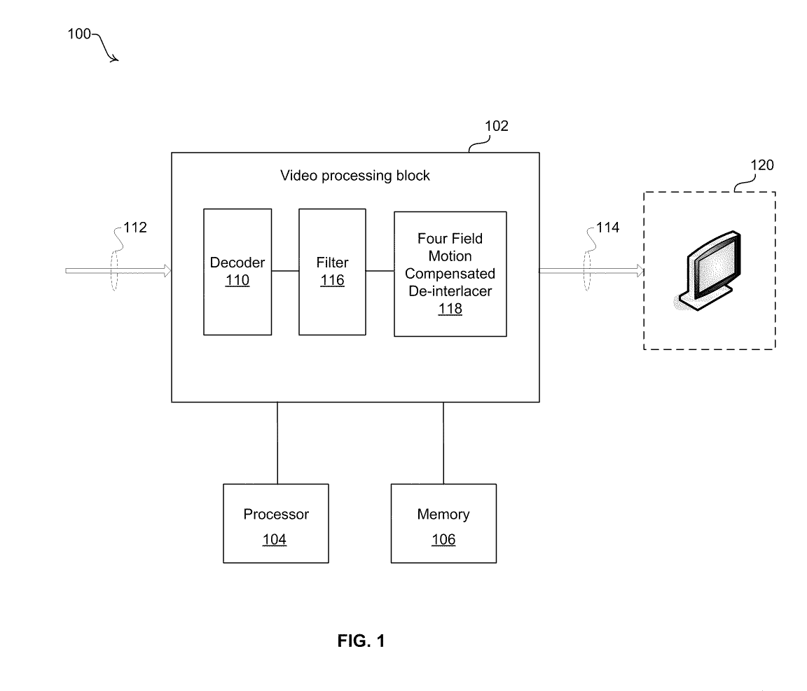

FIG. 1 is a block diagram of an exemplary video processing system for motion compensated video de-interlacing, in accordance with an embodiment of the invention. Referring to FIG. 1, there is shown a video processing system 100, a video processing block 102, a processor 104 and a memory 106. The video processing block 102 may comprise a decoder 110, a filter 116 and a four field motion compensated de-interlacer (MCDI) 118.

The input video stream 112 may comprise a data stream comprising video information. The input video stream 112 may comprise, for example, an encoded video stream which may be generated and/or communicated, for example, via television head-ends and/or audio/video playback devices. The output video stream 114 may comprise a stream of video data that may be suitable for processing via display logic, for example in the display subsystem 120.

The video processing block 102 may comprise suitable logic, circuitry, code and/or interface(s) that may be operable to receive an interlaced video stream 112 and reduce noise and/or de-interlace fields within the input video stream 112. Video fields may alternate parity between top fields and bottom fields. Top fields and bottom fields in interlaced video may be de-interlaced to produce progressive video frame.

The video processing block 102 may be enabled to receive an interlaced video input stream and, in some instances, to decode the received video input stream. In this regard, the decoder 110 may comprise suitable logic, circuitry, and/or code that may be enabled to perform decompression of the received video fields.

The filter 116 in the video processing block 102 may comprise suitable logic, circuitry, code and/or interface(s) that may be operable to perform filtering operation with noise reduction on a current field. The noise may comprise analog noise that may be introduced into pixel data via a video distribution channel. For example, the noise may occur randomly over time and at different pixel and/or sub-pixel positions within a sequence of interlaced video fields. The filter 116 may be operable to detect motion within the stream of video 112 and may utilize a degree of motion, video content, filter coefficients, threshold levels, and/or constants to generate a filtered video output stream. In various embodiments of the invention, the filter 116 may comprise a two field motion compensated temporal filter (MCTF). In this regard, the filter 116 may comprise an infinite impulse response (IIR) filter that may read noise reduced pixel data from a previously output field of the same polarity to generate replacement pixel data. Other embodiments of the invention may comprise a filter that may utilize one or more other previous and/or future fields to filter out noise. Moreover, exemplary embodiments of the invention may filter noise in a spatial domain and/or may utilize motion adaptive techniques.

The filter 116 may comprise suitable logic, circuitry, interface(s) and/or code that may be operable to provide motion estimation and/or motion compensation. In this regard, the filter 116 may be operable to search one or more nearby fields of the same polarity to estimate motion between a current field and a searched field. The filter 116 may determine the direction and/or degree of displacement of pixel imagery. The filter 116 may utilize pixel data from a matched window in a future and/or previous interlace field to interpolate noisy pixel data in a window of a current field.

The four field MCDI 118 may comprise suitable logic, circuitry, code and/or interface(s) that may be operable to receive four fields of interlaced video and output frames of de-interlaced video. The input interlaced fields may comprise video content or may comprise film content. For example, the interlaced video comprising film content may be derived from telecine frames and may comprise 2:2 or 3:2 pulldown frames. The four field MCDI 118 may be operable to estimate motion between a current field and a nearest field having the same polarity. In addition, the four field MCDI 118 may be operable to interpolate missing pixels in a current field based on pixels in fields of opposite polarity that neighbor the current field. In this regard, the four field MCDI 118 may be operable to perform motion estimation that may comprise determining a motion vector that describes a displacement of pixels from a current field to a reference search field. The search field may be a field nearest the current field that has the same polarity as the current field. The motion vector may be determined by specifying a window of pixels in the current field and searching for a match to that window of pixels in the search field. The specified window may be shifted over a specified range in the search field at integer precision shifts or sub pixel (pel) precision shifts, for example, ¼ pel precision. The direction and/or degree of displacement of a matching window may be represented by one or more motion vectors.

The motion vectors may be scaled to determine the displacements, for example, the motion vectors between the current field and a field nearest the current field of opposite polarity. The four field MCDI 118 may be operable to qualify the validity of the determined motion vector(s). For example, the four field MCDI 118 may determine a cost of interpolating pixel data based on pixel data that may be determined by the motion vector(s). In addition, the four field MCDI 118 may blend the data determined based on motion compensated methods with data from other methods of pixel interpolation, for example, motion adaptive or spatial methods. The four field MCDI 118 may generate progressive video frames that may be displayed at twice the rate as the original scanned interlaced fields.

The processor 104 may comprise suitable logic, circuitry, code and/or interface(s) that may be enabled to process data and/or perform system control operations. The processor 104 may be enabled to control at least a portion of the operations of the video processing block 102. Moreover, the processor 104 may be enabled to program, update, and/or modify filter coefficients, threshold levels, and/or constants for the filter 116 and/or the four field MCDI 118.

The memory 106 may comprise suitable logic, circuitry, code and/or interface(s) that may be enabled to store information that may be utilized by the video processing block 102 to reduce noise and/or de-interlace fields of data in the video input stream 112. The memory 106 may be enabled to store instructions and/or configuration data, for example, filter coefficients, threshold levels, and/or constants to be utilized by the video processing block 102. In various embodiments of the invention, the memory 106 may be used to store image data that may be processed and communicated by the processor 104. The memory 106 may also be used for storing code and/or data that may be used by the processor 104. The memory 106 may also be used to store data for other functionalities of the video processing block 102. For example, the memory 106 may store data corresponding to voice and/or data communication.

In operation, the processor 104 may control input of a stream of interlaced video 112 to the video processing block 102. The video processing block 102 may receive the video input stream 112. The video processing block 102 may generate the de-interlaced output video stream 114 after performing decoding operations by the decoder 110, noise reduction filtering by the filter 116 and/or de-interlacing by the four field MCDI 118. In various embodiments of the invention, the four field MCDI 118 may be operable to de-interlace video based on motion compensation methods utilizing four consecutive fields of received interlaced video data. In this regard, the received video may comprise video and/or film content. The four field MCDI may determine motion vectors to ¼ pel precision. The motion estimation may utilize a current field and nearest field of the same polarity as the current field. The motion vectors may be scaled and qualified. A cost of interpolating pixels based on the motion vectors may be determined and may be utilized to blend data determined based on other methods of interpolation with the pixels interpolated based on the four field motion compensation method.

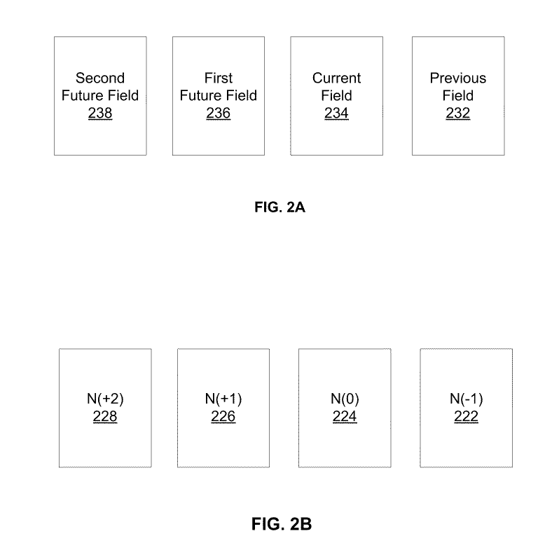

FIG. 2A is a block diagram illustrating an exemplary sequence of interlaced video fields, in accordance with an embodiment of the invention. Referring to FIG. 2A, there is shown four fields of interlaced video comprising a previous field 232, a current field 234, a first future field 236 and a second future field 238.

The previous field 232, the current field 234, the first future field 236 and the second future field 238 may comprise a sequence of interlaced video fields that may be scanned, processed and/or displayed in order from previous fields to future fields. The previous field 232 may represent a field that has already been processed. The previous field 232 may also be a full progressive video frame that may comprise estimated missing pixels. The current field 234 may represent a field that is currently being processed. The first future field 234 may be next in line to be processed followed by the second future field 236. Each of the fields 232, 234, 236 and 238 may comprise approximately half of a video frame of raster scanned lines of pixel data. For example, the previous field 232 and current field 234 may comprise a pair of top and bottom interlaced video fields that together comprise all of the scan lines of a full video frame. Similarly, the first future field 236 and the second future field 238 may also comprise a pair of top and bottom interlaced fields that together comprise all of the scan lines for a full video frame. The first future field 236 and the current field 234 may also comprise a pair of top and bottom interlaced fields that together comprise all of the scan lines for a full video frame.

The top and bottom fields may be referred to as odd and even fields. When the interlaced fields comprise video rather than film content, the top and bottom fields are scanned at different times and may not simply be combined to produce a single de-interlaced frame. The interlaced fields may be de-interlaced by interpolating the missing lines of pixel data in each field. Interpolating the missing lines in an even field may result in a full progressive video frame comprising estimated odd lines. When the interlaced fields comprise film content and/or are derived from telecine frames, a process of inverse telecine weave may be utilized to combine interlaced fields that were scanned from the same frame.

In operation, the sequence of four interlaced video fields 232, 234, 236 and 238 may be processed by a filter to reduce noise and may be processed by the four field de-interlacer 118 described with respect to FIG. 1, to generate progressive video frames. The four interlaced video fields 232, 234, 236 and 238 may be read by or into one or more processors and/or processed in sequence order from the previous field 232 to the second future field 238. When a field is input to the four field de-interlacer 118, the field may be utilized to process a previous field of video. In addition, it may be stored in memory and may be read again into the four field de-interlacer 118 for use in assisting in processing other fields.

FIG. 2B is a block diagram illustrating exemplary indexing for a sequence of interlaced video fields, in accordance with an embodiment of the invention. Referring to FIG. 2B, there is shown four fields of interlaced video comprising N(−1) 222, N(0) 224, N(+1) 226 and N(+2) 228.

The four fields of interlaced video N(−1) 222, N(0) 224, N(+1) 226 and N(+2) 228 may be similar or the same as the four fields of interlaced video shown in FIG. 2A. The four interlaced fields may be indexed such that N(−1) 222 corresponds to the previous field 202, N(0) corresponds to the current field 204, N(+1) corresponds to the first future field 206 and N(+2) corresponds to the second future field 208.

In operation, the sequence of four interlaced video fields N(−1) 222, N(0) 224, N(+1) 226 and N(+2) 228 may be processed by the filter 116, described with respect to FIG. 1, to reduce noise and may be processed by the four field de-interlacer 118 to interpolate the missing pixels in a top or a bottom field to produce a progressive video frame. The four interlaced video fields may be read by or into the four field de-interlacer 118 and may be processed in sequence order from N(−1) 222 to N(+2) 228. When a field is input to the four field de-interlacer 118, it may also be stored in memory. The stored field may be read into the four field de-interlacer 118 and may be utilized to assist in processing other fields.

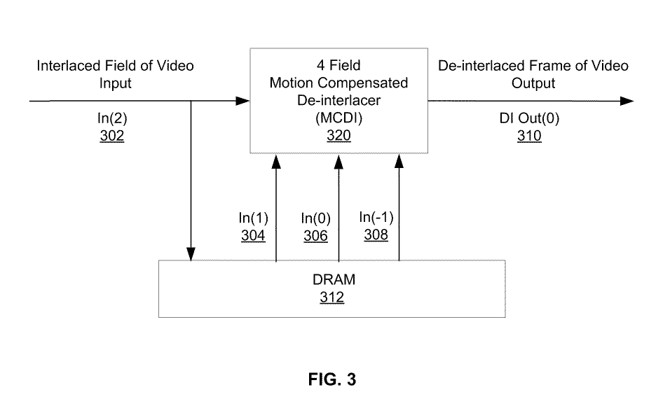

FIG. 3 is a block diagram illustrating an exemplary four field motion compensated de-interlacer, in accordance with an embodiment of the invention. Referring to FIG. 3, there is shown a four field motion compensated de-interlacer (MCDI) 320, an interlaced field input In(2) 302, three previously input interlaced fields In(1) 304, In(0) 306 and In(−1) 308. In addition, a de-interlaced frame output DI Out(0) 310 is shown.

The motion compensated de-interlacer (MCDI) 320 may comprise suitable logic, circuitry, interface(s) and/or code that may be operable to receive interlaced fields of video and output de-interlaced progressive video frames. In this regard, the four field MCDI 320 may be operable to estimate motion and/or motion vectors that occurs between two video fields of the same polarity, for example, from a top field to a nearest top field or a bottom field to a nearest bottom field. The four field MCDI 320 may interpolate missing even lines of pixel data in a field comprising odd lines of data and/or may interpolate missing odd lines of pixel data in a field comprising even lines. The four field MCDI 320 may generate progressive video frames that may be displayed at twice the rate as the original scanned interlaced fields.

The four field MCDI 320 may utilize motion estimation searching techniques to estimate the motion of pixilated imagery from one field to another field. For example, the four field MCDI 320 may search a reference field for pixilated imagery identified in a current field. In this regard, the identified pixilated imagery may be located in a different position in the reference field than in the current field. The current field and reference field may have the same polarity, for example, both may be top fields or both may be bottom fields, and may have a field in between them of an opposite polarity. The MCDI 320 may determine the direction and/or degree of motion or displacement of the pixilated imagery in the reference field relative to the current field. The direction and/or degree of motion may be represented by motion vectors. In this regard, the MCDI 320 may determine the motion vectors by comparing a window of pixel data within a current field, for example, a five by seven window of pixels, with pixel data in a past or future reference field. For example, the pixel data within the search window of the current field may be compared to pixel data within a search window comprising the same dimensions in the reference field.

The search window may be displaced within the reference field to various positions within a specified search range. If a match is found in a past or future field reference field, the motion vectors may be determined based on the displacement of the search window at the position of the match. The MCDI 320 may assume that motion of pixilated imagery occurring among the four fields of video in the MCDI 320 may comprise a constant velocity. In this manner, the MCDI 320 may scale the motion vectors to estimate motion and/or motion vectors between the current field and a neighboring field of the opposite polarity. Thus, the MCDI 320 may interpolate missing pixels in the current field based on pixel data in the neighboring field(s) of opposite polarity. For example, the current field may be missing odd lines of pixel data and the nearest neighbor fields may comprise odd lines of pixel data. The missing odd lines in the current filed may be interpolated based on pixel data in odd lines of one or both of the nearest neighbor fields and vice versa with regard to even lines of pixel data.

The MCDI 320 may determine a level of validity of the motion vectors that are determined based on motion compensation techniques. The level of validity of the motion vectors and/or other information may be utilized to determine reliability of the pixel data that is interpolated based on the motion vectors. In instances when the pixel data has a low(er) level of reliability, the cost of using that pixel data may be high. In this regard, pixel data determined based on one or more other methods of interpolation may be utilized, for example, motion adaptive methods may be utilized for interpolating missing pixels in the current field. Moreover, the pixel data determined based on other methods of interpolation may be blended with the pixel data that may be determined based on the motion vectors. The blending factors may be based on the determined cost of utilizing the pixel data that is determined based on the motion vectors.

The dynamic random access memory (DRAM) 312 may comprise suitable logic, circuitry, interface(s) and/or code that may be operable to store a plurality of fields of interlaced video pixel data. The DRAM 312 may be communicatively coupled to the four field MCDI 320 and/or the filter 116 described with respect to FIG. 1. The DRAM 312 may be operable to write fields of video data to the MCDI 320. The DRAM 312 may be operable to store a field of interlaced video data from the filter 116. For example, three fields of data may be read from the DRAM 312 into the four field MCDI 320 and a fourth field of data may be received by the MCDI 320 and the DRAM 312 from the filter 116.

The interlaced video input In(2) 302 may be a field of interlaced video data that may be scanned over a specified time. The interlaced field In(2) 302 may be input into the four field MCDI 320 and also stored in the DRAM 212. The de-interlacer output frame DI Out(0) 310 may be the result of de-interlacing a field of previously input data, In(0). In this regard, the de-interlaced output frame DI Out(0) 310 may be delayed by two fields relative to the newest interlaced input field In(2). The interlaced inputs In(1) 304, In(0) 306 and In(−1) 308 may be previous inputs to the four field MCDI 320 that may have been stored in the DRAM 212 at the time of their original input into the four field MCDI 320. The previously stored interlaced inputs In(1) 304, In(0) 306 and In(−1) 308 may be read into the four field MCDI 320 for assisting in motion estimation, pixel interpolation and/or the de-interlacing process for the output frame DI Out(0) 310. In this regard, motion estimation may be determined by the four field MCDI 320 based on In(0) an In(2). The motion estimation may be utilized to assist in a de-interlacing process for the output frame DI Out(0) 310.

In operation, the four field MCDI 320 may receive a field of pixel data In(2) 302 and may read three previous inputs In(1) 304, In(0) 306 and In(−1) 308 from the DRAM 312. The four field MCDI 320 may utilize various searching techniques to estimate motion and/or motion vectors between two of the input fields of the same polarity. Motion vectors may be utilized to represent the estimated motion. The motion vectors may be scaled to indicate motion between the current field and nearest neighboring fields of opposite polarity. The four field MCDI 320 may determine a cost for utilizing the motion vectors to determine a method for interpolating missing pixel data in the interlaced fields. The four field MCDI 320 may determine missing pixel data and may output the de-interlacer frame DI Out(0) 310. The DI Out(0) 310 frame may comprise odd and even lines of pixel data and may be displayed at a rate that may be twice the rate of the interlaced fields. In this manner, image resolution may be improved.

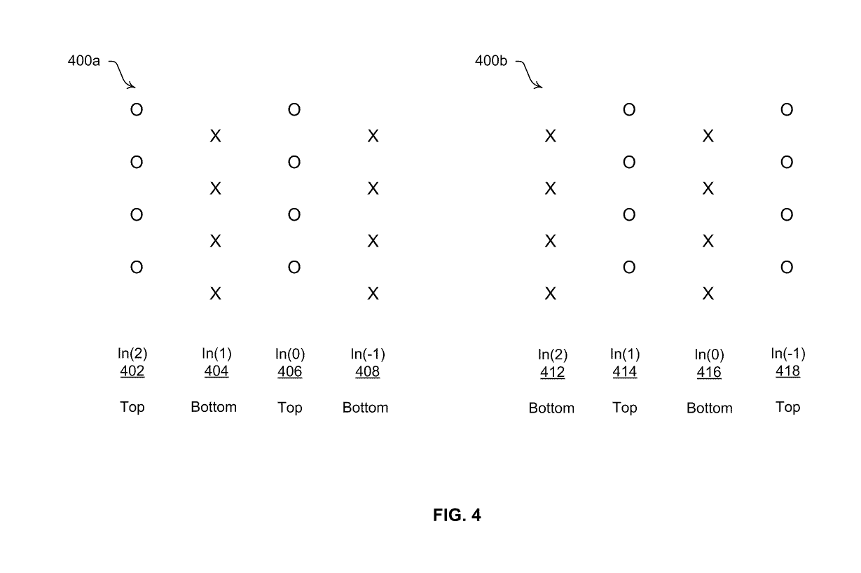

FIG. 4 is a block diagram illustrating two exemplary field orders for four consecutive fields of input to a motion compensated de-interlacer, in accordance with an embodiment of the invention. Referring to FIG. 4, there is shown field order 400a and field order 400b. Field order 400a comprises In(2) 402, In(1) 404, In (0) 406 and In(−1) 408. Field order 400b comprises In(2) 412, In(1) 414, In (0) 416 and In(−1)

The field orders 400a and 400b each comprise four consecutive fields of interlaced video that may alternate between top fields and bottom fields. For example, in field 400a, In(2) 402 is a top field, In(1) 404 is a bottom field, In (0) 406 is a top field and In(−1) 408 is a bottom field. In field 400b, In(2) 412 is a bottom field, In(1) 414 is a top field, In (0) 416 is a bottom field and In(−1) 418 is a top field. In this regard, all the top fields are of the same polarity which is opposite to the polarity of all of the bottom fields. Moreover, the top fields may comprise odd lines of pixel data and may be missing even lines of pixel data or vice versa. The bottom fields may comprise the lines that are missing from the top fields and may be missing the lines that are comprised within the top fields.

In operation, the four field MCDI 320 described with respect to FIG. 3 may comprise suitable logic, circuitry, interfaces and/or code that may be operable to perform motion estimation and/or motion compensated de-interlacing on four consecutive fields in either the top, bottom, top, bottom order of field order 400a and/or the bottom, top, bottom top order of field order 400b.

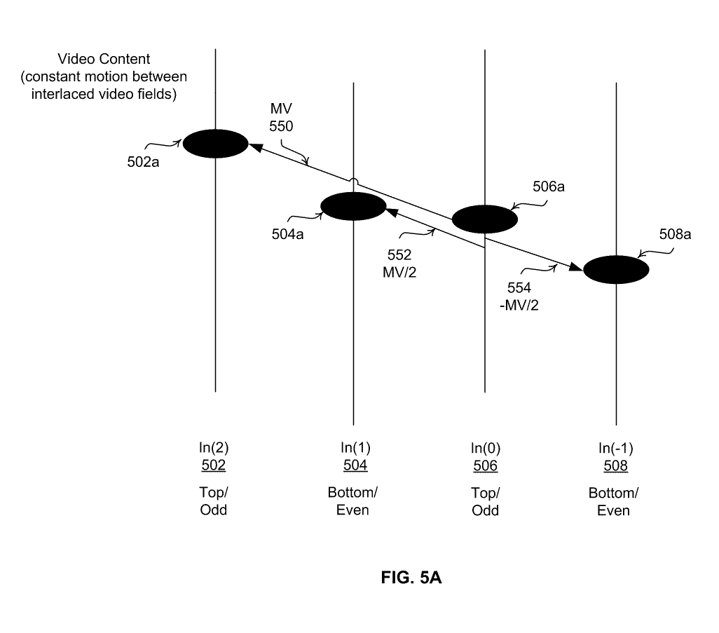

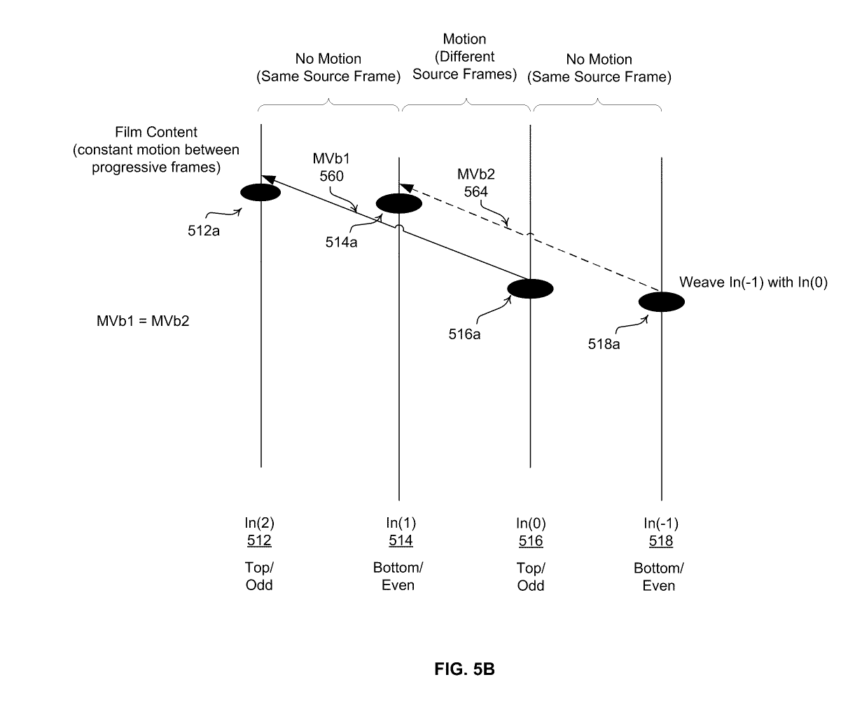

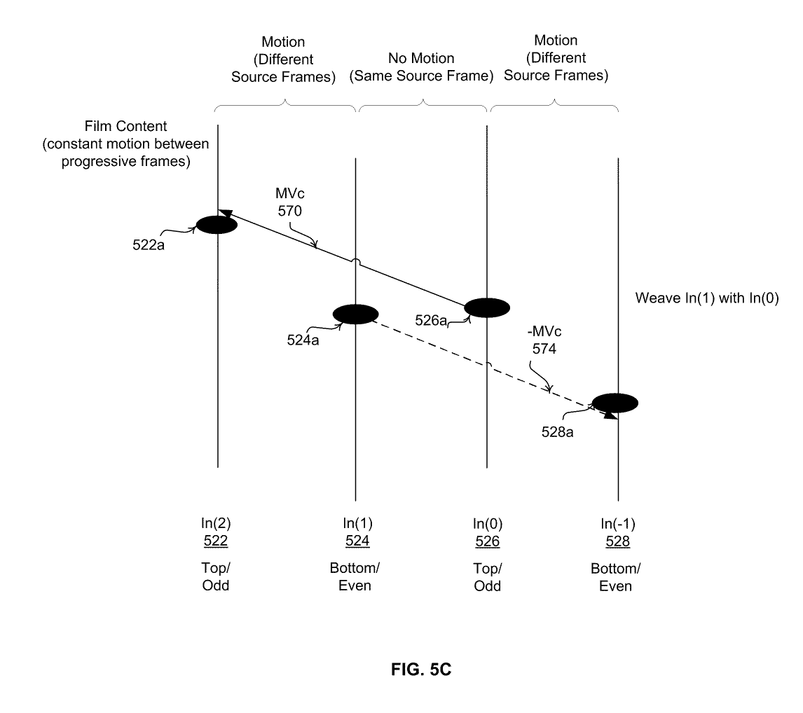

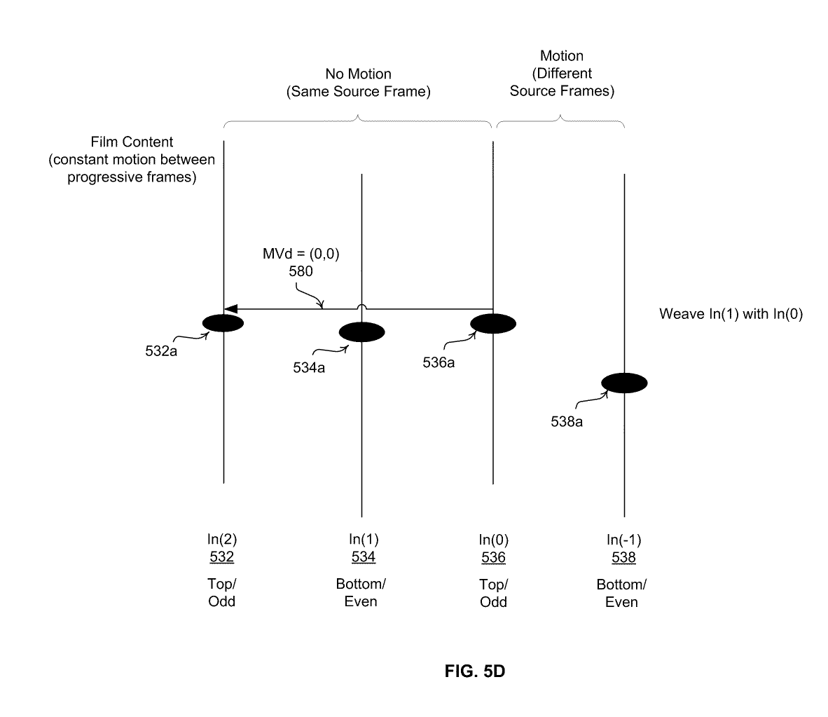

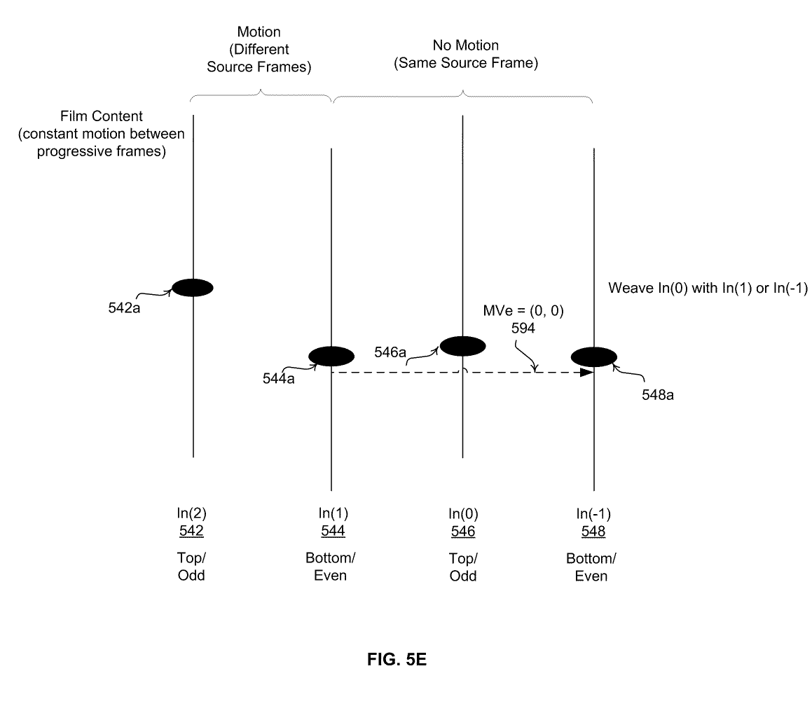

FIG. 5A is a diagram illustrating motion vectors for interlace fields comprising interlaced video content, in accordance with an embodiment of the invention. Referring to FIG. 5A there is shown the interlace fields In(2) 502, In(1) 504, In (0) 506 and In(−1) 508. Within the interlace fields are shown pixel positions 502a, 504a, 506a and 508a. Also shown are the motion vectors MV 550, MV/2 552 and −MV/2 554.

The pixel position 506a may represent a pixel at the position (x0,y) in a current field In(0) 506. The pixel position 502a may represent the same pixel that has been displaced to a different position in the field In(2) 502. Similarly, the pixel positions 504a and 508a may represent the same pixel that has been displaced to a specified position in fields 504 and 508 respectively.

A source of the interlace fields In(2) 502, In(1) 504, In (0) 506 and In(−1) 508 may be interlaced video that may be scanned by a video camera. Each of the fields may comprise even or odd lines. Each of the fields may be scanned at a different time such that there may be some degree of motion between any two consecutive fields. It may be assumed that the motion between any two consecutive fields occurs at a constant velocity. The fields In(2) 502, In(1) 504, In (0) 506 and In(−1) 508 may comprise the top, bottom, top, bottom pattern shown in field order 400a of FIG. 4 or may comprise the bottom, top, bottom, top pattern shown in field order 400b. Motion of an object that may be represented by a plurality of pixels, may be detected by matching the plurality of pixels at different positions in two fields of the same polarity, for example, top field to top field or bottom field to bottom field. In this regard, a motion vector may describe the direction and degree of a displacement of one or more pixels from a position in the current field to a position in the reference field. For example, a pixel at position (x0, y) in field In(0) 506 may be found at a position offset by a motion vector (MV) 550 in field In(2) 502. Due to the assumption of constant velocity between two consecutive fields, it may also be assumed that the pixel at position (x0,y) in field In(0) 506 may be found at a position offset by MV/2 552 in field In(1) 504 of the opposite polarity. Furthermore, the pixel at position (x0, y) of field In(0) 506 may be found in a position offset by −MV/2 554 in field In(−1) 508 of opposite polarity. Motion vectors may be determined at ¼ pel precision. In this regard, one or more pixels from one or more fields of opposite polarity relative to the current field, may be utilized to interpolate a missing pixel in the current field.

FIG. 5B is a diagram illustrating motion vectors for interlace fields comprising film content with a field order suitable for backwards inverse telecine weave, in accordance with an embodiment of the invention. Referring to FIG. 5B there is shown the interlace fields In(2) 512, In(1) 514, In (0) 516 and In(−1) 518. Within the interlace fields are shown pixel positions 512a, 514a, 516a and 518a. Also shown are the motion vectors MVb1 560 and MVb2 564.

The pixel position 516a may represent a pixel at the position (x0,y) in a current field In(0) 516. The pixel position 512a may represent the same pixel that has been displaced to a different position in the field In(2) 512. Similarly, the pixel positions 514a and 518a may represent the same pixel that may be located at different positions in the fields 504 and 508 respectively.

A source of the interlace fields In(2) 512, In(1) 514, In (0) 516 and In(−1) 518 may comprise progressive frames of film. In this regard, the interlaced video fields may be scanned from the progressive film frames. Due to different rates of film and video in some applications and/or due to telecine 2:2 or 3:2 pull down patterns, two consecutive fields of the interlaced video may be scanned from the one progressive frame of film. In this regard, two consecutive fields of opposite polarity where one comprises odd lines and the other comprises even lines may comprise pixels scanned from one progressive film frame. Since the one progressive film frame may be shot at one instant in time, there may not be any motion between the two consecutive fields of opposite polarity. Other pairs of two consecutive interlaced fields of opposite polarity may be scanned from different progressive film frames such that there may be motion between these two consecutive fields. It may be assumed that the motion between any two consecutive progressive film frames occurs at a constant velocity.

The interlaced fields In(2) 512, In(1) 514, In (0) 516 and In(−1) 518 may comprise the top, bottom, top, bottom pattern shown in field order 400a of FIG. 4 or may comprise the bottom, top, bottom, top pattern shown in field order 400b. However, the fields In(2) 512, In(1) 514, may be scanned from the same progressive film frame and thus, there may be no motion between them. Similarly, the fields In (0) 516 and In(−1) 518 may be scanned from one film frame. The motion of an object that may be represented by a plurality of pixels, may be detected by matching the plurality of pixels at different positions in two fields of the same polarity that may be scanned from different film frames. In this regard, a motion vector may describe the direction and degree of a displacement of one or more pixels from a position in the current field In(0) 516 to a position in the reference field In(2) 512. For example, a pixel at position (x0, y) in field In(0) 516 may be found at a position offset by a motion vector MVb1 560 in field In(2) 512. Due to the assumption of constant velocity between two consecutive progressive film frames, it may also be assumed that the pixel at position (x0,y) in field In(−1) 516 may be found at a position offset by MVb2 564 in field In(1) 504 of the same polarity. The motion vector MVb2 564 may be the same as MVb1 560 due to the assumption of constant velocity between progressive frames. In this case, inverse telecine weave may be utilized to back weave the current field In(0) with the field In(−1) 518 of opposite polarity.

FIG. 5C is a diagram illustrating motion vectors for interlace fields comprising film content with a field order suitable for forward inverse telecine weave, in accordance with an embodiment of the invention. Referring to FIG. 5C, there is shown the interlace fields In(2) 522, In(1) 524, In (0) 526 and In(−1) 528. Within the interlaced fields are shown pixel positions 522a, 524a, 526a and 528a. Also shown are the motion vectors MVc 570 and −MVc 574.

The pixel position 526a may represent a pixel at the position (x0,y) in a current field In(0) 526. The pixel position 522a may represent the same pixel that has been displaced to a different position in the field In(2) 522. Similarly, the pixel positions 524a and 528a may represent the same pixel that may be located at different positions in the fields 524 and 528 respectively.

Similar to FIG. 5B, a source of the interlace fields In(2) 522, In(1) 524, In (0) 526 and In(−1) 528 may comprise frames of progressive film wherein interlaced video fields are scanned from the progressive film frames. However, in FIG. 5C, the fields In(0) 526 and field In(1) 524, may be scanned from the same progressive film frame and thus, there may be no motion between them. The field In(2) 522 may be from a later progressive film frame and In(−1) 528 may be scanned from an earlier progressive film frame. In this regard, the motion vector MVc 570 may describe the direction and degree of a displacement of one or more pixels from a position in the current field In(0) 526 to a position in the reference field In(2) 522. Due to the assumed constant velocity between progressive film frames, it may be assumed that a pixel at position (x0,y) in the field In(1) 524 may be found in the field In (−1) 528 in a position offset by the motion vector −MVc 574. In this regard, because interlaced video frames In(1) 524 and In(0) 526 comprise even and odd lines scanned from the same progressive film frame, inverse telecine weave may be utilized to forward weave the current field In(0) 526 with the future field In(1) 524 of opposite polarity.

FIG. 5D is a diagram illustrating motion vectors for interlace fields comprising film content and a 3:2 pull-down pattern with a field order suitable for forward inverse telecine weave, in accordance with an embodiment of the invention. Referring to FIG. 5D, there is shown the interlace fields In(2) 532, In(1) 534, In(0) 536 and In(−1) 538. Within the interlaced fields are shown pixel positions 532a, 534a, 536a and 538a. Also shown is the motion vector MVd 580.

The interlace fields In(2) 532, In(1) 534, In(0) 536 and In(−1) 538 may comprise film content that may have been scanned in a 3:2 pull down pattern. In this regard, one field in every five fields may be repeated. In FIG. 5D, the pixel data of field In(0) 536 may be repeated in the field In(2) 532. Moreover, the fields In(2) 532, In(1) 534 and In(0) 536 may be scanned from the same progressive film frame. Thus, there may be no motion between the fields In(2) 532, In(1) 534 and In(0) 536 and the motion vector MVd 580 may be known to be (0,0). Because interlaced video frames In(1) 534 and In(0) 536 comprise even and odd lines scanned from the same progressive film frame, inverse telecine weave may be utilized to forward weave the current field In(0) 536 with the future field In(1) 534 of opposite polarity.

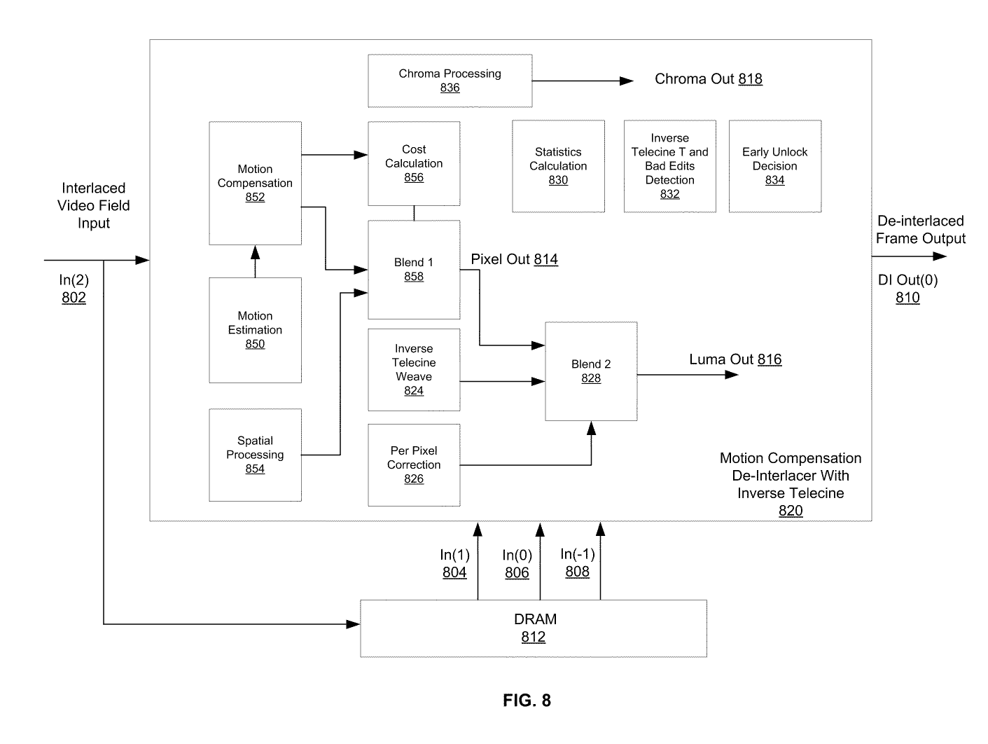

In various embodiments of the invention, the motion vector MVd 580 may be evaluated and may comprise a value greater than (0,0) due to noisy pixel data. In instances when it is known that a 3:2 pull down pattern is utilized, the motion vector comprising noise may be thrown away. The 3:2 pull down pattern may be detected by inverse telecine cadence detection, described with respect to FIG. 8.

FIG. 5E is a diagram illustrating motion vectors for interlace fields comprising film content and a 3:2 pull-down pattern with a field order suitable for forward and/or reverse inverse telecine weave, in accordance with an embodiment of the invention. Referring to FIG. 5E, there is shown the interlace fields In(2) 542, In(1) 544, In (0) 546 and In(−1) 548. Within the interlaced fields are shown pixel positions 542a, 544a, 546a and 548a. Also shown is the motion vector MVe 594.

The interlace fields In(2) 542, In(1) 544, In(0) 546 and In(−1) 548 may comprise film content that may have been scanned in a 3:2 pull down pattern. In this regard, one field in every five fields may be repeated. This pattern may be similar to the pattern in FIG. 5D however the pattern of repetition may be shifted with respect to the current field. Shown in FIG. 5E, the pixel data of field In(−1) 548 may be repeated in the field In(1) 544. Moreover, the fields In(1) 544, In(0) 546 and In(−1) 548 may be scanned from the same progressive film frame. Thus, there may be no motion between the fields In(1) 544, In(0) 546 and In(−1) 548 and the motion vector MVe 594 may be known to be (0,0). Since the interlaced video frames In(1) 544 and In(0) 546 comprise even and odd lines scanned from the same progressive film frame, inverse telecine weave may be utilized to forward weave the current field In(0) 546 with the future field In(1) 544 of opposite polarity. Similarly, because the interlaced video frames In(0) 546 and In(−1) 548 comprise odd and even lines scanned from the same progressive film frame, inverse telecine weave may be utilized to reverse weave the current field In(0) 546 with the previous field In(−1) 548 of opposite polarity.

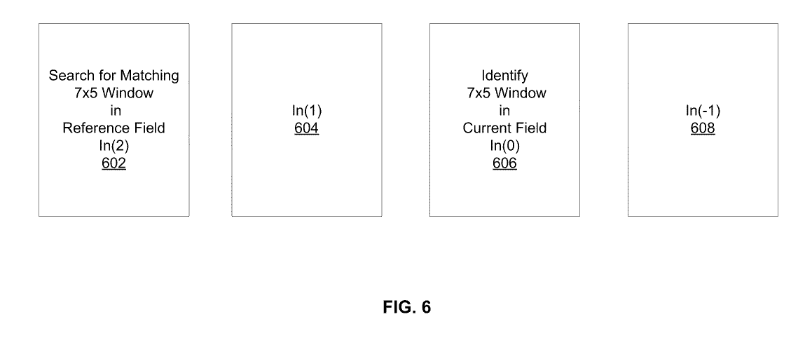

FIG. 6 is a block diagram illustrating an exemplary motion estimation process between a current field and a reference field, in accordance with an embodiment of the invention. Referring to FIG. 6 there is shown four consecutive interlaced video fields a reference field In(2) 602, a field In(1) 604, a current field In(0) 606 and a previous field In(−1) 608.

Aspects of the four consecutive fields In(2) 602, In(1) 604, In(0) 606 and In(−1) 608 are described with respect to FIGS. 2A, 2B, 4, 5A, 5B, 5C, 5D and 5E for example.

In operation, motion estimation may be performed between the current field In(0) 606 and the reference field In(2) 602. In this regard, a motion vector may be determined that may describe the displacement of one or more pixels from a position in the current field, In(0) 606, to a position of matching pixel values in the reference field In(2) 602. An exemplary method for performing a search for matching pixel values and determining a motion vector may comprise defining a search window in the current field In(0) 606 that may be centered at the pixel (x0,y). The search window may be an area of 7×5 pixels that may be centered at a middle pixel of a 3×1 block in the current field In(0) 606. A search may be performed by comparing pixel values in the search window centered at (x0, y) from the current field In(0) 606 with a same size window of pixels at a plurality of positions in the reference field In(2) 602. The search window may initially be placed in a co-located position in the reference window and then displaced over a range of pixels. A search may be performed in a horizontal direction with ¼ pel precision over a range of ±15.75, for example, in the reference field In(2) 602. A search may also be performed in both the horizontal direction and vertical direction with ¼ pel precision within a range in the reference field In(2) 602. The search may be performed first at integer positions until a best match is found. Then, a ¼ pel search may be performed around the best match integer position, for example, at six ¼ pel positions. A determined vector may have a non-zero x component mvx which may be represented in ¼ pel units. The best match search window in the reference field In(2) 606 may be determined based on a cost value that may be determined for each position in which a search is performed. The cost value may indicate a level of confidence for a motion vector that may be determined based on the displacement of the search window in the reference field. In this regard, a cost value may be determined for each displacement and comparison of the search window over a specified range.

The pixel values for the ¼ pel positions that may be utilized for the ¼ pel precision searches may be interpolated by a 2-tap weighted averaging. For example, with P(i, j) representing any of the three components of a pixel (luma, Cb, Cr) at a position (i, j) within a search window, the corresponding component for ¼-pel positions at Q1(x+0.25, y), Q2(x+0.5, y) and Q3(x+0.75, y) may be determined according to the following expressions.

Q1=[3*P(x, y)+P(x+1, y)+2]/4

Q2=[P(x, y)+P(x+1, y)+1]/2

Q3=[P(x, y)+3*P(x+1, y)+2]/4

Once motion estimation is performed for a current pixel and a motion vector is determined, the motion vector may be shared by a block of other pixels around it. For example, a block size of 3×1 may be utilized. In this regard, motion estimation may be performed only once for three consecutive pixels. Although an exemplary block size of 3×1 is disclosed, the block size is not so limited. Accordingly, in various exemplary embodiments of the invention, any block size which does not exceed a size of the search window may be utilized.

For each placement of the search window in the reference field In(2) 602, a cost function may be determined that may indicate a confidence level associated with a motion vector that may be determined by the placement of the search window.

The cost function for a motion estimation search may be defined as a weighted sum of the sum of absolute differences (SAD) of the Y, Cb and Cr components, plus a penalty term for the difference between a motion vector currently being determined and a motion vector of a previous motion estimation search. For example when motion estimation is performed for a current pixel (x0, y), and a search may be at an integer position (x, y), the cost at (x, y) may be defined in the following manner.

$$cost ( x , y ) = \frac{( \begin{matrix}2 * LUMA\_SAD + \\ Cb\_SAD + Cr\_SAD + 2\end{matrix} )}{4} + lamda * ABS ( \begin{matrix}4 * ( x - x 0 ) - \\ pmvx\end{matrix} )$$

$$where$$

$$LUMA\_SAD = {\sum }_{i = - 2}^{i = + 2} {\sum }_{j = - 3}^{+ 3} \vert \begin{matrix}current\_Y ( y + i , x 0 + j ) - \\ reference\_Y ( y + i , x + j )\end{matrix} \vert$$

$$Cb\_SAD = {\sum }_{i = - 2}^{i = + 2} {\sum }_{j = - 3}^{+ 3} \vert \begin{matrix}current\_Cb ( y + i , x 0 + j ) - \\ reference\_Cb ( y + i , x + j )\end{matrix} \vert$$

$$Cr\_SAD = {\sum }_{i = - 2}^{i = + 2} {\sum }_{j = - 3}^{+ 3} \vert \begin{matrix}current\_Cr ( y + i , x 0 + j ) - \\ reference\_Cr ( y + i , x + j )\end{matrix} \vert$$

In this regard, current_Y may represent the Y component of a pixel in the current field In(0) 606, reference_Y may represent the Y component of a pixel in the reference field In(2) 602. Cb and Cr pixel components are represented in a similar manner. lamda maybe a programmable integer value in the range of [0, 255], inclusive, for example, however the range is not so limited. pmvx may be the x-component of a motion vector determined for a previous 3×1 block which may be the 3×1 block to the left of the current 3×1 block. pmvx may be represented in ¼-pel units and may be set to zero for the first 3×1 block of each line. When a vertical search is also performed, the cost may comprise a second penalty item, as defined in the follwing manner.

cost(x,y)=(2*LUMA_SAD+Cb_SAD+Cr_SAD+2)/4+lamda*ABS(4*(x−x0)−pmvx)+lamda2*ABS(4*(y−y0)−pmvy)

In this regard, lamda2 maybe a programmable integer value in the range of [0, 255], inclusive, however, the range is no so limited. Furthermore, pmvy may be the y-component of a motion vector determined for a previous 3×1 block which may be the 3×1 block to the left of the current 3×1 block. pmvy may be represented in ¼-pel units and may be set to zero for the first line of the current field In(0) 606.

At a sub-pixel position of the field In(2) 602, the SAD determinations in the above formulas may utilize interpolated pixel values. Cost values may be determined for scaled motion vectors that may point to search windows in the fields In(1) 604 and In(−1) 608. In this regard, when opposite polarity fields are compared, a top field may be phase shifted down to align with a neighboring bottom field and vice versa. Moreover, cost values may be determined for vertical motion. For example for upward and/or downward motion.

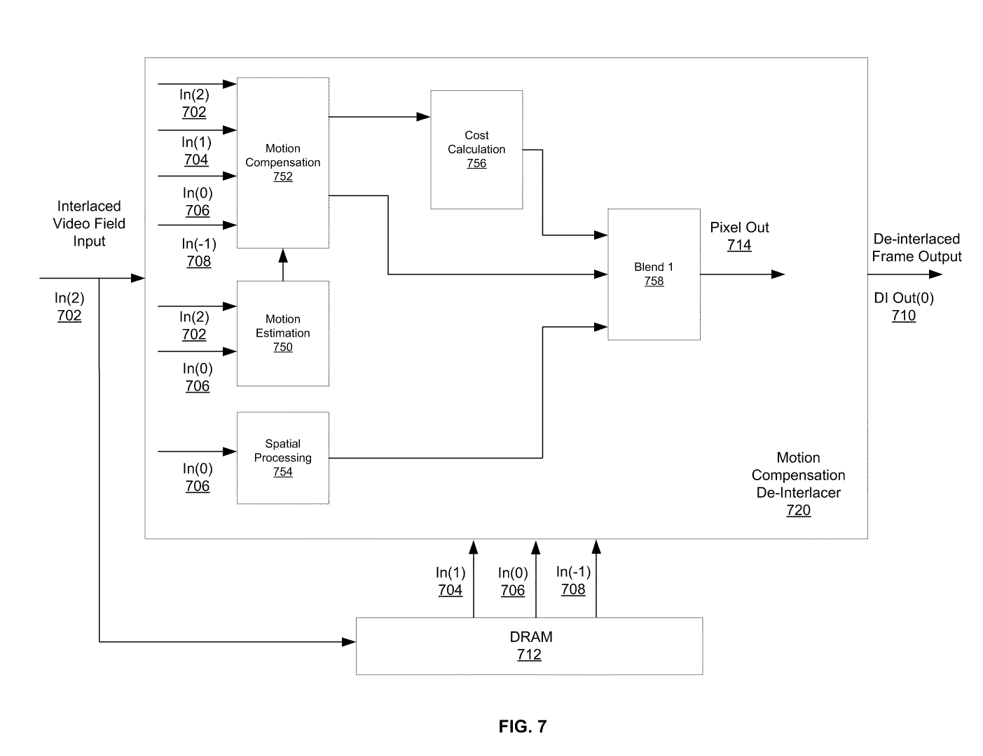

FIG. 7 is a block diagram illustrating an exemplary four field motion compensation de-interlacer, in accordance with an embodiment of the invention. Referring to FIG. 7, there is shown a four field motion compensation de-interlacer 720, a motion estimation module 750, a motion compensation module 752, a spatial processing module 754, a cost calculation module 756 and a blend one module 758. In addition, there is shown a DRAM 712 and input fields to the motion compensation de-interlacer 720, In(2) 702, In(1) 704, In(0) 706 and In(−1) 708. The outputs pixel output 714 and DI Out(0) 710 are also shown.

Aspects of the four consecutive input fields In(2) 702, In(1) 704, In(0) 706 and In(−1) 708 are described with respect to FIGS. 2A, 2B, 4, 5A, 5B, 5C, 5D, 5E and 6 for example. The DI Out(0) 710 may be a de-interlaced progressive frame that may correspond to the current interlaced video input field In(0) 706. The DRAM 712 may be similar or substantially the same as the DRAM 312 described with respect to FIG. 3.

The four field motion compensation de-interlacer (MCDI) 720 may comprise suitable logic, circuitry, interfaces and/or code that may be operable to receive four consecutive fields of interlaced video and output progressive video frames. In this regard, the four field MCDI 720 may be operable to perform motion estimation with ¼ pel precision, motion compensation, spatial prediction, cost calculation and blending of motion compensation interpolated pixels with spatially predicted pixels.

The motion estimation (ME) module 750 may comprise suitable logic, circuitry, interfaces and/or code that may be operable to receive two interlaced video fields, the current field In(0) 706 and the reference field In(2) 702, and to determine motion vectors for motion between the fields. In this regard, the ME module 750 may perform ¼ pel searches as described with respect to FIG. 6. The motion estimation module 750 may be communicatively coupled to the DRAM 712, the motion compensation module 752 and the cost calculation module 756.

The motion compensation (MC) module 752 may comprise suitable logic, circuitry, interfaces and/or code that may be operable to receive four input interlaced fields In(2) 702, In(1) 704, In(0) 706 and In(−1) 708 and may interpolate missing pixels for the current field In(0) 706 based on pixels in a nearest neighbor field of opposite polarity at ¼ pel precision. For example, the MC module 752 may utilize candidate pixels from the neighboring field that may be pointed to by scaled motion vectors. The scaled motion vectors may be based on motion vectors that are associated with a lowest cost value for a particular search range. The candidate pixels in the neighboring field may be interpolated if they are not found at integer search positions.

A pixel value may be interpolated for a missing pixel at (x0, y) in the current field In(0) 706, given a motion vector (mvx, 0) that points to a position in a another field. For example, the motion vector mvx may point to a position, for example, in the field In(k), where mvx may be represented in ¼ -pel units. The luma of the missing pixel at (x0, y) of the current field may be interpolated based on motion compensation methods. The luma of the missing pixel may be denoted as MC_In(k)_Y(y,4*x0+mvx) and it may be interpolated based on two integer value pixels nearby the ¼ pel precision position pointed to by the motion vector in the field In(k). The following illustrated exemplary pseudocode may be utilized for interpolation of a luma content for a missing pixel:

### Let

xx=(4*x0+mvx)/4;

rr=(4*x0+mvx)%4;

If rr=0,

MC_{—}In(k)_{—}Y(y,4*x0+mvx)=In(k)_{—}Y(y,xx)

If rr=1,

MC_{—}In(k)_{—}Y(y,4*x0+mvx)=[3*In(k)_{—}Y(y,xx)+In(k)_{—}Y(y,xx+1)+2]/4

If rr=2,

MC_{—}In(k)_{—}Y(y,4*x0+mvx)=[In(k)_{—}Y(y,xx)+In(k)_{—}Y(y,xx+1)+1]/2

If rr=3,

MC_{—}In(k)_{—}Y(y,4*x0+mvx)=[In(k)_{—}Y(y,xx)+3 *In(k)_{—}Y(y,xx+1)+2]/4

The same motion compensation methods may be used to interpolate the Cb and Cr components of the missing pixel at (x0, y) of the current field In(0) 706.

The spatial processing (SP) module 754 may comprise suitable logic, circuitry, interfaces and/or code that may be operable to determine a spatially interpolated pixel value for the missing pixel at (x0, y) of the current field In(0) 706. The SP module 754 may perform directional processing. The SP module 754 may receive one input, for example, the current input In(0) 706 and may estimate a value for the missing pixel based on intra-field pixel averaging. The SP module 754 may be operable to detect a local direction of an edge and may interpolate along that edge. A pixel value for the missing pixel that may be determined based on spatial methods may be blended with the missing pixel value determined based on motion compensation methods or it may be utilized instead of the motion compensated pixel value. The SP module 754 may be communicatively coupled to the Blend 1 module 758. In various embodiments of the invention, pixel data may be read by the MCDI 720 into an on-chip buffer. In this regard, the SP module 754 and/or other sub-modules may read pixel data from the on-chip buffer and may not be coupled to the DRAM 712.

The cost calculation module 756 may comprise suitable logic, circuitry, interfaces and/or code that may be operable to determine a cost value that may be associated with a motion vector. For example, the cost value described with respect to FIG. 6. In this regard, the cost value may be utilized to determine a blending factor for blending of the motion compensated missing pixel value and the missing pixel value determined based on the spatial methods. For example, when a higher cost value may be associated with a motion compensated pixel value, a lower level of confidence may be assumed in the validity of the motion compensated pixel value. In this regard, a blending process for the motion compensated pixel value and the pixel value determined based on spatial methods may weigh a contribution from the motion compensated value lower than the spatially determined value. The cost calculation module may be communicatively coupled to the MC module 752, the ME module 750 and the blend one module 758.

The blend one module 758 may comprise suitable logic, circuitry, interfaces and/or code that may be operable to blend a motion compensated pixel value from the MC module 752 (MCV) and a pixel value determine based on spatial methods from the SP module 754 (SV) and may generate a motion compensated de-interlace value (MCDV) for the pixel output 714 of the current field In(0) 706. The MCDV value may be determined based a non-linear blending factor α. In this regard, a may have a non-linear, inverse dependence on the cost associated with the pixel value determined by the MC module. The pixel output 714 comprising the MCDV value may be determined according to the following expression:

$$MCDV = \frac{[ ( 256 - α ) * MCV + α * SV + 128 ]}{256} , \\ where$$

$$α = clip 3 ( K 0 * ( 1 - \frac{K 1}{{cost}^{2}} ) , 0 , 256 )$$

clip3( ) is a clipping function:

$$clip 3 ( x , y , z ) = \{ \begin{matrix}y , & if x < y \\ z , & if x > z \\ x , & otherwise\end{matrix}$$

and “cost” is the output value from cost calculation module 756. The constants K0 and K1 may be two programmable integers. In various embodiments of the invention, when K1 may equal zero, then alpha may equal K0. Also, when the cost and/or the cost² is equal to zero, then alpha may equal zero. When the cost and/or the cost² is equal to one, then alpha may be equal to K0*(1−K1).

In operation, the four field motion compensation de-interlacer (MCDI) 720 may comprise suitable logic, circuitry, interfaces and/or code that may be operable to receive four consecutive fields of interlaced video and output progressive video frames. In this regard, the four field MCDI 720 may be operable to perform motion estimation with ¼ pel precision to determine one or more a motion vectors. The motion vectors may be determined based on search window comparisons over a range of pixels in a reference field In(2) 702. The four field MCDI 720 may determine a most valid motion vector based on a cost value that may be determined for each motion estimation search. In addition, the four field MCDI 720 may scale a motion vector that may point to a neighboring field of opposite polarity. A cost value may be determined for the scaled motion vector. The four field MCDI 720 may interpolate one or more missing pixels in the current field In(0) 706 based on pixels in the opposite polarity field with ¼ pel precision. In addition, based on the determined cost value for the most valid motion vector, the four field MCDI 720 may blend pixels that are interpolated based on motion compensation methods with pixels interpolated based on intra-field spatial prediction. The output DI Out(0) 710 from the four field MCDI 720 may be delayed by two field processing periods from when the corresponding interlaced input In(0) 706 is first input to the 4-field MCDI 720 through input 702.

FIG. 8 is a block diagram illustrating an exemplary four field motion compensation de-interlacer with inverse telecine, in accordance with an embodiment of the invention. Referring to FIG. 8, there is shown a four field motion compensation de-interlacer with inverse telecine 820, a motion estimation module 850, a motion compensation module 852, a spatial processing module 854, a cost calculation module 856 and a blend one module 858. In addition, there is shown a DRAM 812, input fields In(2) 802, In(1) 804, In(0) 806 and In(−1) 808 and a pixel output 814. In addition, there is shown an inverse telecine weave module 824, a per pixel correction module 826, a blend two module 828, a statistics calculation module 830, an inverse telecine and bad edits detection module 832 and an early unlock decision module 834. A progressive frame output DI Out(0) 810 is also shown.

Various aspects of the four consecutive input fields In(2) 802, In(1) 804, In(0) 806 and In(−1) 808 are described with respect to FIGS. 2A, 2B, 4, 5A, 5B, 5C, 5D, 5E, 6 and 7 for example. The DI Out(0) 810 may be a de-interlaced progressive frame that may correspond to the current interlaced video input field In(0) 806. The DRAM 812 may be similar or substantially the same as the DRAM 312 described with respect to FIG. 3.

The four field motion compensation de-interlacer (MCDI) with inverse telecine (IT) 820 may comprise suitable logic, circuitry, interfaces and/or code that may be operable to receive four consecutive fields of interlaced video and output progressive video frames. In this regard, the four field MCDI-IT 820 may be operable to perform motion estimation with ¼ pel precision, motion compensation, spatial prediction, cost calculation and blending of motion compensation interpolated pixels with spatially predicted pixels. In addition, the MCDI-IT 820 may be operable to handle interlaced video that may comprise progressive film frame content. The four field MCDI-IT may be operable to de-interlace fields of video via a motion compensation path, a spatial processing path and an inverse telecine weave path. The four field MCDI-IT may be operable to perform a first blending of pixel values that may be determined via the motion compensation path and the spatial processing path and may perform a second blending with the outcome of the first blending and a pixel value determined via the inverse telecine path.

The motion estimation (ME) module 850, the motion compensation (MC) module 852, the spatial processing (SP) module 854, the cost calculation module 856 and the blend one module 858 may be similar and/or substantially the same as the motion estimation (ME) module 750, the motion compensation (MC) module 752, the spatial processing (SP) module 754, the cost calculation module 756 and the blend one module 758 of the motion compensation de-interlacer (MCDI) 720 described with respect to FIG. 7.

The inverse telecine (IT) weave module 824 may comprise suitable logic, circuitry, interfaces and/or code that may be operable to calculate statistics for In(1) 804, detect inverse telecine cadence and determine missing pixels in In(0) 806 for fields comprising film content described with respect to FIG. 5B, FIG. 5C, FIG. 5D and FIG.5E. With regard to cadence detection, the IT weave module 824 may be operable to determine which interlaced fields are scanned from the same progressive film frames. In this regard, the IT weave module 824 may be operable to determine a 2:2 and/or 3:2 pull down pattern for example. In some instances, two or three consecutive interlaced frames may be scanned from one progressive film frame.

The per pixel correction (PPC) module 826 may comprise suitable logic, circuitry, interfaces and/or code that may be operable to determine a blending factor (ppcv) for the blend two module 828. The blending factor for the blend two module 828 may be utilized to blend the output of the Blend 1 module 858 with the IT weave value from the IT weave module 824. In addition, the PPC module may be operable to accumulate frame level unexpected motion values that may be utilized to detect inverse telecine. After the accumulation is done for an entire field, the values may be sent to the inverse telecine and bad edit detection module 832.

The blend two module 828 may comprise suitable logic, circuitry, interfaces and/or code that may be operable to receive the blended motion MCDV pixel value, described with respect to FIG. 7, from the blend one module 858 and perform a second level blending with the IT weave value (ITV) from the IT weave module 824. The second level blending may be based on the blending factor ppcv determined by the PPC module 826. The luma component of the final missing pixel value (Y_Final) may be determined by the following exemplary expression:

$$Y\_Final = \frac{[ ( 256 - α\_IT ) * ITV + α\_IT * MCDV + 128 ]}{256}$$

$$where$$

$$α\_IT = clip 3 ( K 0 \_IT * ( 1 - \frac{K 1 \_IT}{{ppcv}^{2}} ) , 0 , 256 )$$

The constants K0_IT and K1_IT may be two programmable integers.
The chroma components of the final missing pixel value (Y_Final) may be determined by a similar manner.

The statistics calculation module 830 may comprise suitable logic, circuitry, interfaces and/or code that may be operable to values that may be utilized for inverse telecine cadence detection and bad edits detection. The statistics may be determined for the field In(1) 804 while other de-interlacing processes may work on the current field In(0) 806. Three groups of statistical data may be determined and communicated to other modules, motion compensation statistics, inverse telecine statistics and early unlock statistics. The IT cadence detection and bad-edit detection tasks may be performed immediately after the statistics are collected for an entire field.

The inverse telecine (IT) and bad edits detection module 832 may comprise suitable logic, circuitry, interfaces and/or code that may be operable to detect a 3:2 or 2:2 or other pull down pattern. The IT and bad edits module 832 may send control information to the IT weave module 824 and/or the PPC module 826 in order to properly weave consecutive fields scanned from a single progressive film frame.

The early unlock decision module 834 may comprise suitable logic, circuitry, interfaces and/or code that may be operable to determine an early cadence unlock decision for each pixel. The early unlock decision may be determined after statistics may be collected for each pixel. The IT weave decision may be incorrect in instances when cadence may be disrupted in a field, for example, when a bad edit occurs. In this regard, an activated early unlock allows the following pixels not to use IT weaving although that particular de-interlaced frame may have weaving artifacts at pixels before the early unlock is activated. The following frames may utilize motion compensation methods.

In operation, the four field motion compensation de-interlacer (MCDI) with inverse telecine (IT) 820 may comprise suitable logic, circuitry, interfaces and/or code that may be operable to receive four consecutive fields of interlaced video and output progressive video frames. The four field MCDI-IT 820 may be operable to perform motion estimation with ¼ pel precision to determine one or more motion vectors. The motion vectors may be determined based on search window comparisons over a range of pixels in a reference field In(2) 802. The four field MCDI-IT 820 may determine a most valid motion vector based on a cost value that may be determined for each motion estimation search. In addition, the four field MCDI-IT 820 may scale a motion vector that may point to a neighboring field of opposite polarity. A cost value may be determined for the scaled motion vector. The four field MCDI-IT 820 may interpolate one or more missing pixels in the current field In(0) 806 based on pixels in the opposite polarity field with ¼ pel precision.

In addition, based on the determined cost value for the most valid motion vector, the four field MCDI-IT 820 may perform a first blending of pixel values that may be interpolated based on motion compensation methods with pixel values that may be interpolated based on intra-field spatial prediction. In this regard, the output of the blend one module may comprise a motion compensated de-interlaced pixel value MCDV. In addition an IT weave path in the MCDI-IT 820 may generate a weaving value according to an IT phase that may be locked at a frame level by the IT and bad edits detection module 832. The weaving value and the MCDV value may be sent to the blend two module 858. A second blending process may be controlled based on a per-pixel blending factor that may be calculated by the PPC module 826. The output DI Out(0) 810 from the four field MCDI-IT 820 may comprise a progressive video frame of pixel values output from the blend two module 858. The output DI Out(0) 810 may be delayed by two field processing periods from when a corresponding interlaced input field In(0) 806 is first input to MCDI-IT 810.

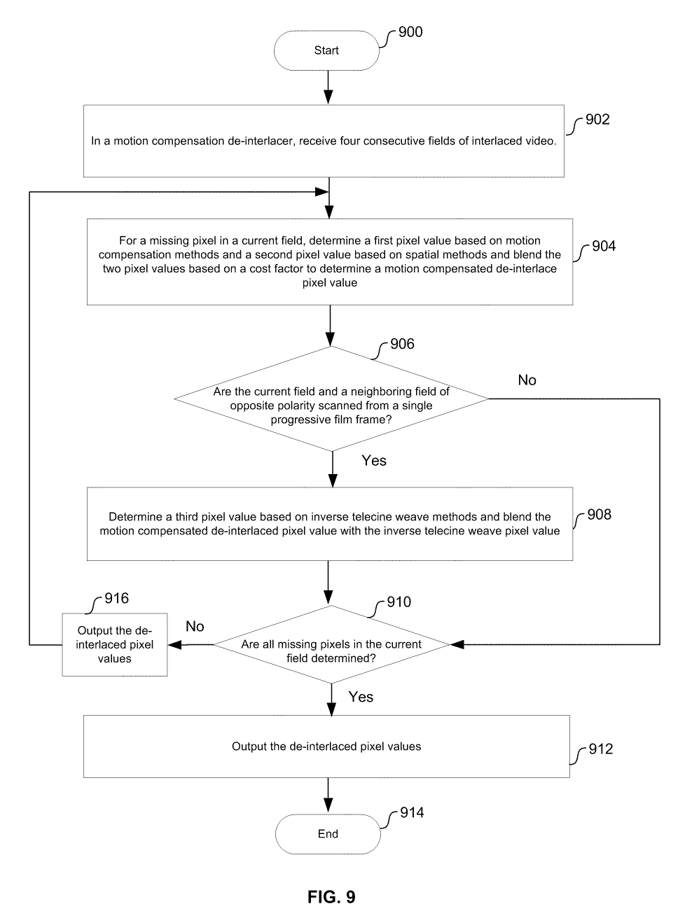

FIG. 9 illustrates exemplary steps for de-interlacing video fields with a four field motion compensation de-interlacer with inverse telecine, in accordance with an embodiment of the invention. Referring to FIG. 9, the exemplary steps may begin with start step 900. In step 902, in a motion compensated de-interlacer 820, four consecutive fields of interlaced video, In(2) 802, In(1) 804, In(0) 806 and In(0) 808 may be received. In step 904, for a missing pixel in a current field In(0) 806, a first pixel value may be determined based on motion compensation methods and a second pixel value based on spatial methods and blend the two pixel values in the blend one module 858 based on a cost factor to determine a motion compensated de-interlace pixel value. In step 906, if the current field In(0) 806 and a neighboring field of opposite polarity, for example, In(1) 804 or In(−1) 808 are scanned from a single progressive film frame, the exemplary steps proceed to step 908. In step 908, a third pixel value may be determined based on inverse telecine weave methods and blend the motion compensated de-interlaced pixel value with the inverse telecine weave pixel value in the blend two module 828. In step 910, if all missing pixels in the current field are determined, proceed to step 912. In step 912, output the de-interlaced pixels for progressive video frame DI Out(0) 810. The exemplary steps may end with step 914. In step 906, if the current field In(0) 806 and a neighboring field of opposite polarity, for example, In(1) 804 or In(−1) 808 are not scanned from a single progressive film frame, the exemplary steps proceed to step 910. In step 910, if the missing pixels in the current field are not all determined, the exemplary steps proceed to step 916. In step 916, output the de-interlaced pixels for progressive video frame DI Out(0) 810.

In an embodiment of the invention, a motion compensated de-interlacer (MCDI) 720 and/or 820 may read four consecutive fields of interlaced pixel data for example, In(2) 602, In(1) 604, In(0) 606, In(−1) 608. Utilizing one or more of the four consecutive fields, the MCDI 720 and/or 820 may convert a current field of interlaced pixel data In(0) 606 to a de-interlaced frame of pixel data. In this regard, motion may be estimated between two of the four consecutive fields, for example, In(0) 606 and In(2) 602. The motion may be estimated with up to ¼ pel precision. A motion vector may be determined based on searching a field, for example, In(2) 602 from the four consecutive fields that may comprise a same polarity as In(0) 606. The motion vector may be scaled with up to ¼ or ⅛ pel precision for a field of the four consecutive fields comprising an opposite polarity, for example, the field In(1) 604 or In(−1) 608. A level of validity may be determined for the motion vector and/or the scaled motion vector. A motion compensated pixel value may be interpolated for a current field, for example, In(0) 606 of the four consecutive fields based on a second field comprising an opposite polarity, for example, In(1) 604 or In(−1) 608. The interpolated motion compensated pixel value may be blended with one or more pixel values that may be determined based on other methods of de-interlacing. The four consecutive fields of interlaced pixel data may comprise video content and/or film content.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for motion compensated video de-interlacing.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing video data, the method comprising:
in a video processing system comprising a motion compensated de-interlacer:
reading four consecutive fields of interlaced pixel data by said motion compensated de-interlacer; and
converting a current field of interlaced pixel data to a de-interlaced frame of pixel data utilizing one or more of said read four consecutive fields of interlaced pixel data.

2. The method according to claim 1, comprising estimating motion vectors between two fields of said read four consecutive fields of interlaced pixel data.

3. The method according to claim 1, comprising estimating motion vectors between two fields of said read four consecutive fields of interlaced pixel data with up to ¼ pel precision.

4. The method according to claim 1, comprising determining a motion vector based on a search of a field of said read four consecutive fields of interlaced pixel data comprising a same polarity.

5. The method according to claim 4, comprising scaling said motion vector with up to ¼ and/or ⅛ pel precision for a field of said read four consecutive fields of interlaced pixel data comprising an opposite polarity.

6. The method according to claim 5, comprising determining a level of validity of said motion vector and/or said scaled motion vector.

7. The method according to claim 1, comprising interpolating a motion compensated pixel value for a current field of said four consecutive fields based on a second field of said four consecutive fields of interlaced pixel data comprising an opposite polarity.

8. The method according to claim 1, comprising blending said interpolated motion compensated pixel value with one or pixel values determined based on other methods of de-interlacing.

9. The method according to claim 1, wherein said read four consecutive fields of interlaced pixel data comprise video content and/or film content.

10. A system for processing video data, the system comprising:
one or more circuits for use in a video processing system, said one or more circuits comprising a motion compensated de-interlacer, wherein said one or more circuits are operable to:
read four consecutive fields of interlaced pixel data by said motion compensated de-interlacer; and
convert a current field of interlaced pixel data to a de-interlaced frame of pixel data utilizing one or more of said read four consecutive fields of interlaced pixel data.

11. The system according to claim 10, wherein said one or more circuits are operable to estimate motion vectors between two fields of said read four consecutive fields of interlaced pixel data.

12. The system according to claim 10, wherein said one or more circuits are operable to estimate motion vectors between two fields of said read four consecutive fields of interlaced pixel data with up to ¼ pel precision.

13. The system according to claim 10, wherein said one or more circuits are operable to determine a motion vector based on a search of a field of said read four consecutive fields of interlaced pixel data comprising a same polarity.

14. The system according to claim 13, wherein said one or more circuits are operable to scale said motion vector with up to ¼ and/or ⅛ pel precision for a field of said read four consecutive fields of interlaced pixel data comprising an opposite polarity.

15. The system according to claim 14, wherein said one or more circuits are operable to determine a level of validity of said motion vector and/or said scaled motion vector.

16. The system according to claim 10, wherein said one or more circuits are operable to interpolate a motion compensated pixel value for a current field of said four consecutive fields based on a second field of said four consecutive fields of interlaced pixel data comprising an opposite polarity.

17. The system according to claim 10, wherein said one or more circuits are operable to blend said interpolated motion compensated pixel value with one or pixel values determined based on other methods of de-interlacing.

18. The system according to claim 10, wherein said read four consecutive fields of interlaced pixel data comprise video content and/or film content.
